(19) United States
(12) Patent Application Publication
(10) Pub. No.: US 2012/0132465 A1
(43) Pub. Date: May 31, 2012

(54) WIRE HARNESS ARRANGEMENT STRUCTURE

(75) Inventor: Miyoshi MABUCHI, Shizuoka (JP)

(73) Assignee: YAZAKI CORPORATION, Tokyo (JP)

(21) Appl. No.: 13/303,330

(22) Filed: Nov. 23, 2011

(30) Foreign Application Priority Data
Nov. 24, 2010 (JP) 2010-261255

(51) Int. Cl. H02G 3/02

(52) U.S. Cl. 174/72 A

(57) ABSTRACT

A wire harness having clamping members for clamping a bundle of wires. Each clamping members includes band portions for binding the wires into a rod-shape; a base portion integral with the band portions and contacting the peripheral of a clamp attachment hole in the vehicle body panel; and a panel connection portion protruding from a surface of the base portion and fixed to the clamp attachment hole. The base portion is configured to ensure a separation distance between a surface of the wire bundle and a surface of the vehicle body panel. A variation in a separation distance between the clamping members is prevented by the rigidity of the bundle of the wires.

The disclosure of Japanese Patent Application No. 2010-261255 filed on Nov. 24, 2010, including specification, drawings and claims is incorporated herein by reference in its entirety.

### BACKGROUND

The invention relates to a wire harness arrangement structure for fixing a wire harness including a plurality of wires to a wire harness arrangement path on a vehicle body panel.

FIGS. 6 to 8C are explanatory diagrams showing a wire harness arrangement structure according to the related art.

The wire harness arrangement structure illustrated in FIG. 6 is disclosed in Patent Document 1.

The wire harness arrangement structure of Patent Document 1 includes a plurality of wires 102 constituting a wire harness 101, and a plurality of clamping members 111 fixing a bundle of wires 102 to a wire harness arrangement path on a vehicle body panel.

The wire harness 101 has, as shown in FIG. 6, a structure in which an outer periphery of the wires 102 is surrounded by an exterior material 104.

The clamping members 111 are, as illustrated in FIG. 6, mounted on a connection band body 121 provided vertically at an outer periphery of the exterior material 104. The connection band body 121 includes, as illustrated in FIG. 7, latch portions 121b having saw-toothed irregularities continuously formed at both sides of a band plate 121a.

Each of the clamping members 111 includes a band body connecting portion 112 having a band body insertion through hole 112a through which the connection band body 121 is inserted, and a panel connection portion 113 formed to protrude from an outer peripheral surface of the band body connecting portion 112. The band body connecting portion 112 includes latch protrusions (not shown) which are formed in the band body insertion through hole 112a to be latched into the latch portions 121b. The band body connecting portion 112 may be positioned at a certain position on the connection band body 121 by latching between the latch protrusions and the irregularities of the latch portions 121b.

The panel connection portion 113 of each of the clamping members 111 is fitted to a clamp attachment hole of a vehicle body panel (not shown) to be fixed to the vehicle body panel.

In the wire harness arrangement structure described in Patent Document 1, a separation distance L1 between the clamping members 111 can be adjusted by sliding the clamping members 111 on the connection band body 121 in a longitudinal direction (direction of arrow X1 of FIG. 6) of the connection band body 121.

The clamping members 111 mounted on the connection band body 121 are fixed to an outer periphery of the wire harness 101 by fixing the connection band body 121 to the outer periphery of the exterior material 104 by using bands 131.

The wire harness arrangement structure illustrated in FIGS. 8A to 8C is disclosed in Patent Document 2.

In the wire harness arrangement structure of Patent Document 2, a plurality of wires 152 constituting a wire harness 151 are inserted into a protector 141 made of resin. Further, clamping members 161 are attached to an outer periphery of the protector 141 to be slidable in a longitudinal direction (direction of arrow X2 of FIG. 8C) of the protector 141.

The protector 141 is formed of, e.g., rigid resin, and includes, as shown in FIG. 8A, a bottom wall 141a, and a pair of movable walls 141b and 141c rotatably extending at both sides of the bottom wall 141a. As represented by solid lines in FIG. 8A, when the movable walls 141b and 141c are bent such that their leading ends face each other, the leading ends of the movable walls 141b and 141c are fitted and connected to each other, thereby assembling a cylindrical structure having a specific section.

The wires 152 inserted to pass through the protector 141 are bound into a bundle by winding an adhesive tape 154 on the outer periphery of the wires 152.

Each of the clamping members 161 includes, as shown in FIG. 8B, a protector connection portion 162 which is fitted to the protector 141, and a panel connection portion 163 which is formed to protrude from the protector connection portion 162.

The protector connection portion 162 has a shape corresponding to a circumferential part of a cylindrical structure fitted to the outer periphery of the protector 141.

The panel connection portion 163 is fixed to a vehicle body panel (not shown) by being fitted to a clamp attachment hole of the vehicle body panel.

In the wire harness arrangement structure described in Patent Document 2, a separation distance L2 between the clamping members 161 can be adjusted by sliding the clamping members 161 on the protector 141 in the longitudinal direction of the protector 141.

Patent Document 1: JP-UM-A-5-045372

Patent Document 2: JP-A-7-143647

However, in the wire harness arrangement structure disclosed in Patent Document 1 and Patent Document 2, the clamping members 111 and 161 for coupling the wire harness to the vehicle body panel are respectively attached to the exterior material 104 and the protector 141 surrounding the outer periphery of the wires 102 and 152 without being directly attached to the wires 102 and 152 forming the wire harness.

Accordingly, in these wire harness arrangement structures, there is a problem in which the wire harness is expensive and heavy due to equipment such as the exterior material 104 and the protector 141.

Further, the clamping members 111 and 161 attached to the exterior material 104 and the protector 141 are attached movably in the longitudinal direction of the wire harnesses 101 and 151 respectively.

Accordingly, in the wire harness arrangement structures disclosed in Patent Documents 1 and 2, in an assembly with respect to the vehicle body panel, some of the clamping members may move in the longitudinal direction of the wire harness, and the separation distance between the clamping members may be changed from a design value. In this case, since the separation distance between the clamping members does not coincide with the separation distance between the clamp attachment holes formed on the vehicle body panel, it is necessary to adjust the positions of the clamping members, thereby causing a delay in the arrangement operation.

Further, in the wire harness arrangement structure disclosed in Patent Document 2, the wires 152 forming the wire harness 151 are fitted loosely into the protector 141, and the wire harness 151 is movable by a specific amount in a direction (direction of arrow Y2 of FIG. 8C) perpendicular to the longitudinal direction.

Accordingly, the wire harness may shake in the direction perpendicular to the longitudinal direction due to, e.g., vibration when driving a vehicle such that the wires 152 exposed from the protector 141 interfere with a vehicle body, thereby causing damage to the wires 152.

### SUMMARY

It is therefore an object of the present invention to provide a wire harness arrangement structure capable of achieving the low cost and light weight by reducing the number of components, facilitating an arrangement operation in a wire harness arrangement path on a vehicle body panel by suppressing a variation in a separation distance between a plurality of clamping members mounted on a wire harness, and preventing wires constituting the wire harness from being damaged due to friction with the vehicle body panel.

The object of the present invention can be achieved by the following configurations of (1) to (3).

(1) A wire harness arrangement structure, comprising: a plurality of wires constituting a wire harness; and a plurality of clamping members fixing a bundle of the wires to a wire harness arrangement path on a vehicle body panel, wherein the wires have such a flexural rigidity that the bundle of the wires maintains a bent shape corresponding to a shape of the wire harness arrangement path, wherein each of the clamping members includes: band portions directly binding an outer periphery of the wires to form the bundle of the wires into a rod-shape; a base portion which is formed integrally with the band portions and is in contact with a peripheral portion of a clamp attachment hole on the vehicle body panel; and a panel connection portion which is provided so as to protrude from a surface of the base portion which is in contact with the peripheral portion and is fixed to the clamp attachment hole, wherein the base portion is configured to ensure a separation distance between a surface of the bundle of the wires fixed to the band portions and a surface of the vehicle body panel to maintain a non-contact state between the bundle of the wires and the vehicle body panel in a state where the panel connection portion is fixed to the clamp attachment hole, and wherein a variation in a separation distance between the clamping members fixed to the bundle of the wires is prevented by the rigidity of the bundle of the wires.

(2) The wire harness arrangement structure according to (1), wherein the surface of the base portion, with which the bundle of the wires is in contact is provided with a movement prevention protrusion configured to form a bent portion in the bundle of the wires and to prevent the bundle of the wires from moving in a longitudinal direction thereof.

(3) A wire harness arrangement structure, comprising: a plurality of wires constituting a wire harness; a plurality of clamping members fixing a bundle of the wires to a wire harness arrangement path on a vehicle body; a rod-shaped member having a rigidity for maintaining a bent shape corresponding to a shape of the wire harness arrangement path, the rod-shaped member which is arranged along the wires and is fixedly equipped with the clamping members which are spaced from each other in a longitudinal direction of the wires; and binding members directly binding the rod-shaped member and the wires to form the bundle of the wires having a bent shape corresponding to a bent shape of the rod-shaped member, wherein each of the clamping members includes: a base portion which is fixed to the rod-shaped member and is in contact with a peripheral portion of a clamp attachment hole on the vehicle body panel; and a panel connection portion which is provided so as to protrude from a surface of the base portion which is in contact with the peripheral portion and is fixed to the clamp attachment hole, wherein the base portion is configured to ensure a separation distance between a surface of the bundle of the wires and a surface of the vehicle body panel to maintain a non-contact state between the bundle of the wires and the vehicle body panel in a state where the panel connection portion is fixed to the clamp attachment hole, and wherein a variation in a separation distance between the clamping members fixed to the bundle of the wires is prevented by the rigidity of the rod-shaped member.

By the configuration of (1), the clamping members include the band portions which directly bind the outer periphery of a plurality of wires forming the wire harness. Accordingly, it is possible to directly attach the clamping members to the wire harness without mounting an exterior material or protector on the outer periphery of the wires.

Accordingly, it is possible to achieve the low cost and light weight by reducing the number of components by omitting the exterior material or protector.

Further, by the configuration of (1), the clamping members include the band portions which are firmly fixed directly to the wire harness. Accordingly, a plurality of the clamping members mounted on the wire harness do not move unnecessarily in the longitudinal direction of the wire harness, thereby preventing a variation in the separation distance between the clamping members.

Further, wires having a high flexural rigidity are employed as a plurality of wires forming the wire harness. The wires bundled by the band portions of the clamping members have a rigidity to maintain a bent shape corresponding to the shape of the wire harness arrangement path.

Accordingly, the wire harness to which the clamping members are attached is not loosened unnecessarily, thereby preventing a variation in the separation distance between the clamping members due to deformation such as relaxation of the wire harness or the like.

Accordingly, it may not cause a problem in which the positions of some of the clamping members do not coincide with the positions of the clamp attachment holes on the vehicle body panel due to a variation in the separation distance between the clamping members, thereby facilitating an arrangement operation in the wire harness arrangement path on the vehicle body panel.

Further, by the configuration (1), it is possible to ensure the separation distance between the surface of the bundle of wires arranged and the surface of the vehicle body panel to maintain a non-contact state between the bundle of wires and the vehicle body panel by the synergy effect of the rigidity of the bundle of wires and the base portions provided in the clamping members.

Accordingly, it is possible to prevent the wires forming the wire harness from being damaged due to friction with the vehicle body panel.

By the configuration (2), the movement prevention protrusion on the surface of the base portion is fitted to the bent portion of the bundle of wires, thereby further increasing a bonding force of the clamping members attached to the wire harness restricting the movement in the longitudinal direction of the wire harness. Accordingly, it is possible to further increase performance preventing a variation in the separation distance between the clamping members.

By the configuration (3), a plurality of the clamping members are fixedly mounted on the rod-shaped member, and also, the plural wires forming the wire harness are bound to the rod-shaped member by the binding members. Accordingly, it is possible to attach the clamping members to the wire harness without mounting an exterior material or protector on the outer periphery of the plural wires.

Accordingly, it is possible to achieve the low cost and light weight by reducing the number of components by omitting the exterior material or protector.

Further, by the configuration (3), the rod-shaped member to which the clamping members are fixed has a rigidity maintaining a bent shape corresponding to the shape of the wire harness arrangement path. Accordingly, it is possible to prevent the rod-shaped member from being bent unnecessarily, thereby preventing a variation in the separation distance between the clamping members.

Accordingly, it may not cause a problem in which the positions of some of the clamping members do not coincide with the positions of the clamp attachment holes on the vehicle body panel due to a variation in the separation distance between the clamping members, thereby facilitating an arrangement operation in the wire harness arrangement path on the vehicle body panel.

Further, by the configuration (3), it is possible to ensure the separation distance between the surface of the bundle of wires arranged and the surface of the vehicle body panel to maintain a non-contact state between the bundle of wires and the vehicle body panel by the rigidity assigned to the bundle of wires due to the rod-shaped member and the base portions provided in the clamping members.

Accordingly, it is possible to prevent the wires forming the wire harness from being damaged due to friction with the vehicle body panel.

According to the wire harness arrangement structure of the invention, it is possible to attach the clamping members to the wire harness without mounting an exterior material or protector on the outer periphery of the wires forming the wire harness.

Accordingly, it is possible to achieve the low cost and light weight by reducing the number of components by omitting the exterior material or protector.

Further, according to the wire harness arrangement structure of the invention, a variation in the separation distance between the clamping members assembled to the wire harness is prevented by the rigidity of the wires forming the wire harness or the rigidity of the rod-shaped member provided in the longitudinal direction of the bundle of wires.

Accordingly, it may not cause a problem in which the positions of some of the clamping members do not coincide with the positions of the clamp attachment holes on the vehicle body panel due to a variation in the separation distance between the clamping members, thereby facilitating an arrangement operation in the wire harness arrangement path on the vehicle body panel.

Further, according to the wire harness arrangement structure of the invention, it is possible to ensure the separation distance between the surface of the bundle of wires arranged and the surface of the vehicle body panel to maintain a non-contact state between the bundle of wires and the vehicle body panel by the rigidity assigned to the bundle of wires the base portions provided in the clamping members.

Accordingly, it is possible to prevent the wires forming the wire harness from being damaged due to friction with the vehicle body panel.

### BRIEF DESCRIPTION OF THE DRAWINGS

In the accompanying drawings:

FIG. 1 schematically shows a configuration of a wire harness that is fixed to a vehicle body panel in a wire harness arrangement structure according to a first embodiment of the invention;

FIG. 2 is an enlarged side view showing an arrangement structure in which a main trunk of the wire harness shown in FIG. 1 is fixed to the vehicle body panel;

FIG. 3 schematically shows a configuration of a wire harness that is fixed to a vehicle body panel in a wire harness arrangement structure according to a second embodiment of the invention;

FIG. 4 is an enlarged side view showing an arrangement structure in which a main trunk of the wire harness shown in FIG. 3 is fixed to the vehicle body panel;

FIGS. 5A to 5C are explanatory diagrams showing the directions of clamping members when a rod-shaped member is provided in a spiral shape on the outer periphery of the plural wires in the arrangement structure of the second embodiment;

FIG. 6 is a perspective view showing a wire harness arrangement structure according to the related art;

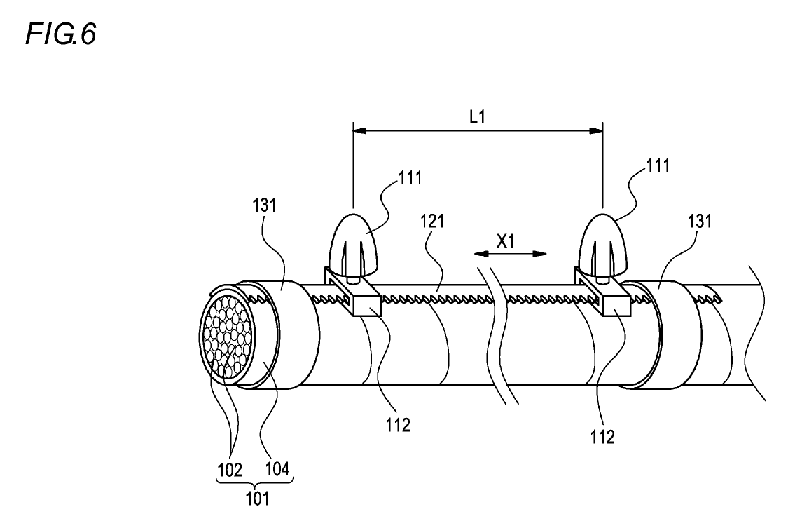

FIG. 7 is a perspective view showing a clamping member and a connection band body illustrated in FIG. 6; and

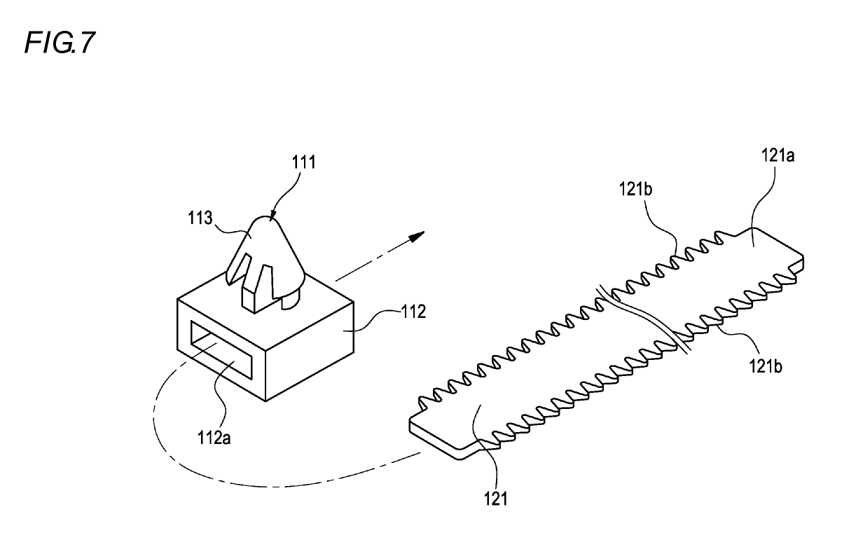

FIGS. 8A to 8C are perspective views showing another wire harness arrangement structure according to the related art.

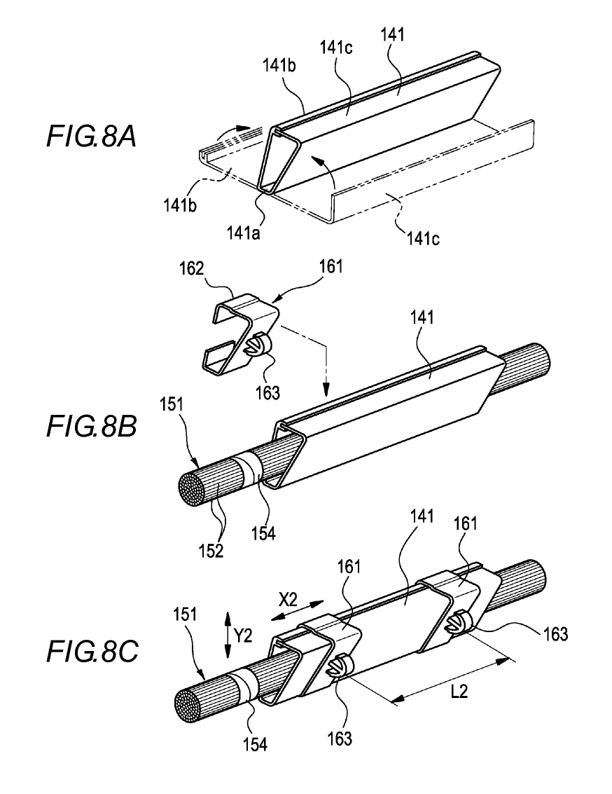

### DETAILED DESCRIPTION OF THE EMBODIMENTS

Hereinafter, a wire harness arrangement structure according to embodiments of the invention will be described in detail with reference to the accompanying drawings.

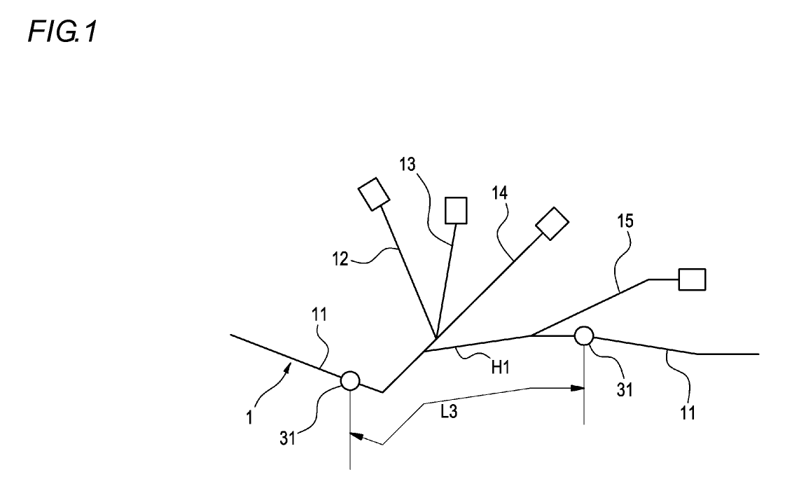

FIG. 1 schematically shows a configuration of a wire harness that is fixed to a vehicle body panel in a wire harness arrangement structure according to a first embodiment of the invention.

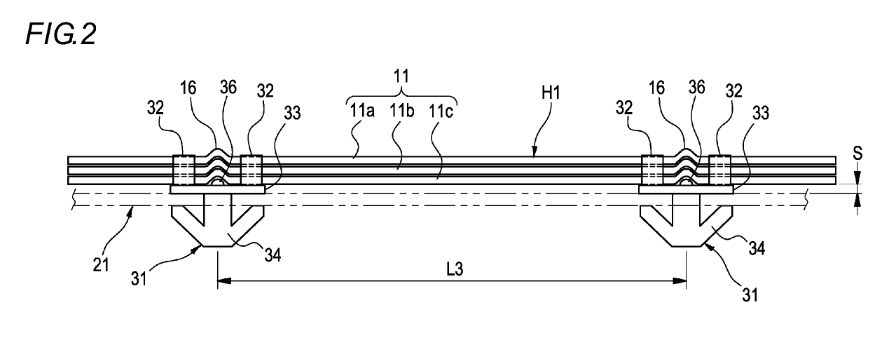

A wire harness 1 illustrated in FIG. 1 includes a main trunk 11 from which four branches 12, 13, 14 and 15 extend. The main trunk 11 includes both end portions of an intermediate section L3 in a longitudinal direction having a wire harness arrangement structure H1 of the first embodiment as shown in FIG. 2, and is fixed to a vehicle body panel 21.

The wire harness arrangement structure H1 of the first embodiment is, as illustrated in FIG. 2, a structure for fixing a bundle of three wires 11a, 11b and 11c forming the main trunk 11 in the wire harness 1 to a wire harness arrangement path on the vehicle body panel 21 by two clamping members 31.

In this embodiment, the three wires 11a, 11b and 11c are flat wires, each having a band plate-shaped single conductor covered with insulation, and are stacked by band portions 32 that will be described later, thereby forming a bundle of wires. An insulated wire using a single conductor has a flexural rigidity higher than that of a general insulated wire using a twisted conductor.

Specifically, the rigidity of each of the wires 11a, 11b and 11c is selected to have a sufficient rigidity maintaining a bent shape when a bundle of the three wires 11a, 11b and 11c is molded in the bent shape corresponding to the shape of the wire harness arrangement path on the vehicle body panel 21.

For example, if a diameter of the bundle of wires of the main trunk 11 is equal to or larger than 10 mm, the rigidity necessary for the three wires 11a, 11b and 11c forming the main trunk 11 is a flexural rigidity at which a horizontal misalignment load between the bundle of wires and the clamping members 31 is equal to or larger than 60 N, and a rotational load in the torsional displacement of the clamping members 31 is equal to or larger than 30 N. Further, if the diameter of the bundle of wires of the main trunk 11 is smaller than 10 mm, the rigidity necessary for the three wires 11a, 11b and 11c is a flexural rigidity at which the horizontal misalignment load between the bundle of wires and the clamping members 31 is equal to or larger than 30 N.

Each of the clamping members 31 includes, as illustrated in FIG. 2, the band portions 32, a base portion 33 and a panel connection portion 34.

The band portions 32 directly bind the outer periphery of the three wires 11a, 11b and 11c, thereby forming a rod-shaped bundle of wires with a high rigidity. The band portions 32 are formed integrally with the base portion 33. Further, the band portions 32 are formed at two places spaced from each other in the longitudinal direction of the wire harness in one of the clamping members 31.

The base portion 33 is formed integrally with the band portions 32 as described above. The base portion 33 is in contact with a peripheral portion of a clamp attachment hole (not shown) on the vehicle body panel 21 as illustrated in FIG. 2.

The panel connection portion 34 is an umbrella-shaped protrusion which is fitted and fixed to the clamp attachment hole (not shown). The panel connection portion 34 is formed to protrude from the surface of the base portion 33 in contact with the peripheral portion of the clamp attachment hole.

More specifically, the panel connection portion 34 is protrudingly formed at a central portion of the base portion 33. Further, the above-mentioned two band portions 32 are provided at two places while the central portion of the base portion 33 is interposed between the two places.

In this embodiment, the base portion 33 ensures a separation distance S between the surface of the bundle of wires fixed to the band portions 32 and the surface of the vehicle body panel 21 to maintain a non-contact state between the bundle of wires and the vehicle body panel 21 in a state where the panel connection portion 34 is fixed to the clamp attachment hole as shown in FIG. 2.

The separation distance S is set to be greater than a maximum deflection of the bundle of wires in the section L3 in which the wire harness is fixed by a pair of the clamping members 31. Accordingly, the separation distance S is set such that the bundle of wires is not in contact with the surface of the vehicle body panel 21 even though the bundle of wires is bent.

Further, in the wire harness arrangement structure H1 of this embodiment, a movement prevention protrusion 36 is formed on the surface of the base portion 33 to protrude toward the bundle of wires. The movement prevention protrusion 36 generates a bent portion 16 in the bundle of wires. Accordingly, the movement prevention protrusion 36 is fitted to the bent portion 16, thereby preventing the bundle of wires from moving in the longitudinal direction.

In the above-described wire harness arrangement structure H1 of this embodiment, a variation in a separation distance L3 between the clamping members 31 fixed to the bundle of wires is prevented by the rigidity of the bundle of wires.

In the above-described wire harness arrangement structure H1 of the first embodiment, the clamping members 31 include the band portions 32 which directly bind the outer periphery of the three wires 11a, 11b and 11c forming the wire harness 1. Accordingly, it is possible to directly attach the clamping members 31 to the wire harness 1 without mounting an exterior material or protector on the outer periphery of the three wires 11a, 11b and 11c.

Accordingly, it is possible to achieve the low cost and light weight by reducing the number of components by omitting the exterior material or protector.

Further, in the above-described wire harness arrangement structure H1 of the first embodiment, the clamping members 31 include the band portions 32 which are firmly fixed directly to the wire harness 1. Accordingly, a plurality of the clamping members 31 mounted on the wire harness 1 do not move unnecessarily in the longitudinal direction of the wire harness 1, thereby preventing a variation in the separation distance L3 between the clamping members 31.

Further, wires having a high flexural rigidity are employed as the three wires 11a, 11b and 11c forming the wire harness 1. The three wires 11a, 11b and 11c bundled by the band portions 32 of the clamping members 31 have a rigidity to maintain a bent shape corresponding to the shape of the wire harness arrangement path.

Accordingly, the wire harness 1 to which the clamping members 31 are attached is not loosened unnecessarily, thereby preventing a variation in the separation distance L3 between the clamping members 31 due to deformation such as relaxation of the wire harness 1 or the like.

Accordingly, it may not cause a problem in which the positions of some of the clamping members 31 do not coincide with the positions of the clamp attachment holes on the vehicle body panel 21 due to a variation in the separation distance L3 between the clamping members 31, thereby facilitating an arrangement operation in the wire harness arrangement path on the vehicle body panel 21.

Further, in the above-described wire harness arrangement structure H1 of the first embodiment, it is possible to ensure the separation distance S between the surface of the bundle of wires arranged and the surface of the vehicle body panel 21 to maintain a non-contact state between the bundle of wires and the vehicle body panel 21 by the synergy effect of the rigidity of the bundle of wires and the base portions 33 provided in the clamping members 31.

Accordingly, it is possible to prevent the wires 11a, 11b and 11c forming the wire harness 1 from being damaged due to friction with the vehicle body panel 21.

Further, in the above-described wire harness arrangement structure H1 of the first embodiment, the movement prevention protrusion 36 on the surface of the base portion 33 is fitted to the bent portion 16 of the bundle of wires, thereby further increasing a bonding force of the clamping members 31 attached to the wire harness 1 restricting the movement in the longitudinal direction of the wire harness. Accordingly, it is possible to further increase performance preventing a variation in the separation distance L3 between the clamping members 31.

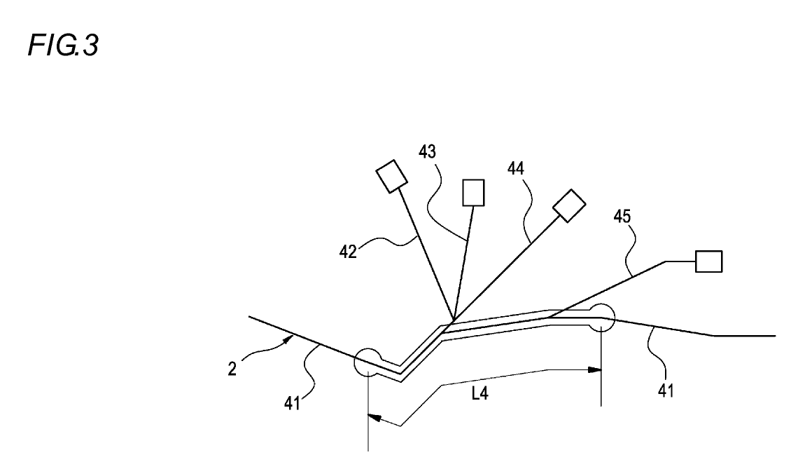

FIG. 3 schematically shows a configuration of a wire harness that is fixed to a vehicle body panel in a wire harness arrangement structure according to a second embodiment of the invention.

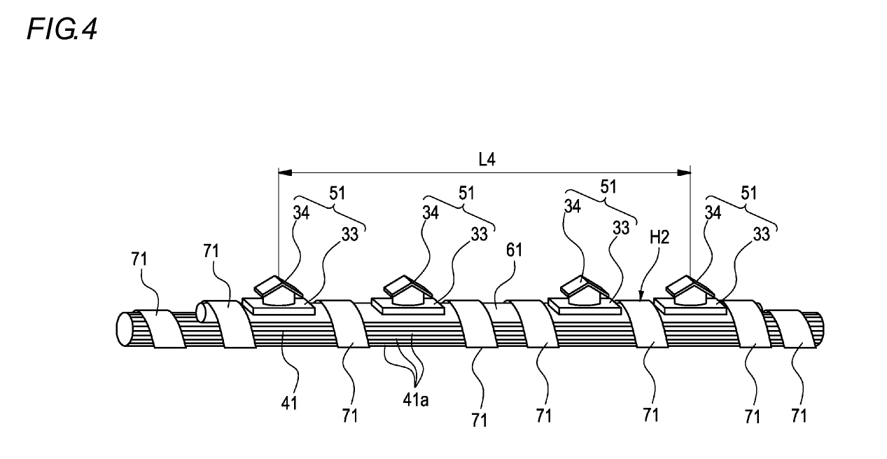

A wire harness 2 illustrated in FIG. 3 includes a main trunk 41 from which four branches 42, 43, 44 and 45 extend. The main trunk 41 includes an intermediate section L4 in a longitudinal direction having a wire harness arrangement structure H2 of the second embodiment as shown in FIG. 4, and is fixed to a vehicle body panel.

The wire harness arrangement structure H2 of the second embodiment is, as illustrated in FIG. 4, a structure for fixing a bundle of plural insulated wires 41a forming the main trunk 41 in the wire harness 2 to a wire harness arrangement path on a vehicle body panel (not shown) by four clamping members 51.

In this embodiment, each of the plural insulated wires 41a forming the main trunk 41 may be a general insulated wire using a twisted conductor or a high rigidity insulated wire using a single conductor.

In the wire harness arrangement structure H2 of the second embodiment, a rod-shaped member 61 and binding members 71 are used in addition to the clamping members 51 in order to fix the main trunk 41 to the vehicle body panel.

The rod-shaped member 61 has a rigidity maintaining a bent shape corresponding to the shape of the wire harness arrangement path, and is provided in a longitudinal direction of the plural insulated wires 41a. Further, in this embodiment, the rod-shaped member 61 is formed of the same material as that of the clamping members 51 and the four clamping members 51 are fixedly mounted on the rod-shaped member 61 to be spaced from each other in the longitudinal direction. A method of fixing the clamping members 51 to the rod-shaped member 61 is selected according to the material of those members. For example, if the rod-shaped member 61 and the clamping members 51 are formed of resin, the clamping members 51 are fixed by ultrasonic welding or using an adhesive. Further, if the rod-shaped member 61 and the clamping members 51 are formed of metal, the clamping members 51 are fixed by welding.

The binding members 71 directly bundle the rod-shaped member 61 and the plural insulated wires 41a, thereby forming a bundle of wires having a bent shape corresponding to the bent shape of the rod-shaped member 61. An adhesive tape or a bonding band made of resin is used as the binding members 71. Further, the intervals of the binding members 71 are adjusted such that the plural insulated wires 41a are not separated from the rod-shaped member 61. Generally, it is preferable that the binding members 71 are mounted at both sides of the clamping members 51. However, if there is a large interval between the adjacent clamping members 51, the number of the binding members 71 may be increased.

In this embodiment, each of the clamping members 51 fixedly mounted on the rod-shaped member 61 includes a base portion 33 and a panel connection portion 34.

The base portion 33 is a plate-shaped member which is fixed to the rod-shaped member 61 and in contact with a peripheral portion of a clamp attachment hole on the vehicle body panel. It is preferable that the base portion 33 of each of the clamping members 51 has the same structure of the base portion 33 of each of the clamping members 31 of the first embodiment.

The panel connection portion 34 is a member which is formed to protrude from the surface of the base portion 33 and fixed to the clamp attachment hole of the vehicle body panel. It is preferable that the panel connection portion 34 of each of the clamping members 51 has the same structure of the panel connection portion 34 of each of the clamping members 31 of the first embodiment.

Also in this embodiment, the base portion 33 ensures the separation distance S (see FIG. 2) between the surface of the bundle of wires and the surface of the vehicle body panel to maintain a non-contact state between the bundle of wires and the vehicle body panel in a state where the panel connection portion 34 is fixed to the clamp attachment hole as shown in FIG. 2.

Further, in this embodiment, a variation in the separation distance between the clamping members 51 fixed to the bundle of wires is prevented by the rigidity of the rod-shaped member 61.

In the above-described wire harness arrangement structure H2 of the second embodiment, a plurality of the clamping members 51 are fixedly mounted on the rod-shaped member 61, and also, the plural insulated wires 41a forming the wire harness 2 are bound to the rod-shaped member 61 by the binding members 71. Accordingly, it is possible to attach the clamping members 51 to the wire harness 2 without mounting an exterior material or protector on the outer periphery of the plural insulated wires 41a.

Accordingly, it is possible to achieve the low cost and light weight by reducing the number of components by omitting the exterior material or protector.

Further, in the above-described wire harness arrangement structure H2 of the second embodiment, the rod-shaped member 61 to which the clamping members 51 are fixed has a rigidity maintaining a bent shape corresponding to the shape of the wire harness arrangement path. Accordingly, it is possible to prevent the rod-shaped member 61 from being bent unnecessarily, thereby preventing a variation in the separation distance between the clamping members 51.

Accordingly, it may not cause a problem in which the positions of some of the clamping members 51 do not coincide with the positions of the clamp attachment holes on the vehicle body panel due to a variation in the separation distance between the clamping members 51, thereby facilitating an arrangement operation in the wire harness arrangement path on the vehicle body panel.

Further, in the above-described wire harness arrangement structure H2 of the second embodiment, it is possible to ensure the separation distance between the surface of the bundle of wires arranged and the surface of the vehicle body panel to maintain a non-contact state between the bundle of wires and the vehicle body panel by the rigidity assigned to the bundle of wires due to the rod-shaped member 61 and the base portions 33 provided in the clamping members 51.

Accordingly, it is possible to prevent the wires forming the wire harness 2 from being damaged due to friction with the vehicle body panel.

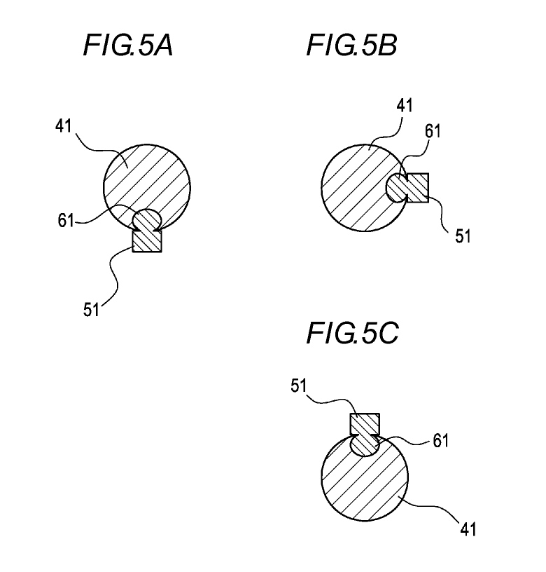

Further, although the rod-shaped member 61 is provided simply in the longitudinal direction on the outer periphery of the main trunk 41 in the second embodiment, the rod-shaped member 61 may be mounted in a spiral shape on the outer periphery of the main trunk 41. In this case, as shown in FIGS. 5A, 5B and 5C, the protruding direction of the clamping members 51 is changed according to the position in the longitudinal direction of the wire harness.

Further, the wire harness arrangement structure of the invention is not limited to the above-described embodiments, and appropriate modification and improvement and the like are possible. For example, the number of the clamping members used for fixing the wire harness to the vehicle body panel, the detailed shape of the panel connection portion 34 of the clamping members and the like may be appropriately changed in design.

The invention is not limited to the above-described embodiments, and appropriate modification and improvement and the like can be made. Further, in the above-described embodiments, no limitation is imposed on the material, shape, dimension, value, form, number, installation position and the like of each of the components if the invention can be achieved.

1. A wire harness arrangement structure, comprising:
a plurality of wires constituting a wire harness; and
a plurality of clamping members fixing a bundle of the wires to a wire harness arrangement path on a vehicle body panel,
wherein the wires have such a flexural rigidity that the bundle of the wires maintains a bent shape corresponding to a shape of the wire harness arrangement path,
wherein each of the clamping members includes:
band portions directly binding an outer periphery of the wires to form the bundle of the wires into a rod-shape;
a base portion which is formed integrally with the band portions and is in contact with a peripheral portion of a clamp attachment hole on the vehicle body panel; and
a panel connection portion which is provided so as to protrude from a surface of the base portion which is in contact with the peripheral portion and is fixed to the clamp attachment hole,
wherein the base portion is configured to ensure a separation distance between a surface of the bundle of the wires fixed to the band portions and a surface of the vehicle body panel to maintain a non-contact state between the bundle of the wires and the vehicle body panel in a state where the panel connection portion is fixed to the clamp attachment hole, and
wherein a variation in a separation distance between the clamping members fixed to the bundle of the wires is prevented by the rigidity of the bundle of the wires.

2. The wire harness arrangement structure according to claim 1, wherein the surface of the base portion, with which the bundle of the wires is in contact is provided with a movement prevention protrusion configured to form a bent portion in the bundle of the wires and to prevent the bundle of the wires from moving in a longitudinal direction thereof.

3. A wire harness arrangement structure, comprising:
a plurality of wires constituting a wire harness;
a plurality of clamping members fixing a bundle of the wires to a wire harness arrangement path on a vehicle body;
a rod-shaped member having a rigidity for maintaining a bent shape corresponding to a shape of the wire harness arrangement path, the rod-shaped member which is arranged along the wires and is fixedly equipped with the clamping members which are spaced from each other in a longitudinal direction of the wires; and
binding members directly binding the rod-shaped member and the wires to form the bundle of the wires having a bent shape corresponding to a bent shape of the rod-shaped member,
wherein each of the clamping members includes:
a base portion which is fixed to the rod-shaped member and is in contact with a peripheral portion of a clamp attachment hole on the vehicle body panel; and
a panel connection portion which is provided so as to protrude from a surface of the base portion which is in contact with the peripheral portion and is fixed to the clamp attachment hole,
wherein the base portion is configured to ensure a separation distance between a surface of the bundle of the wires and a surface of the vehicle body panel to maintain a non-contact state between the bundle of the wires and the vehicle body panel in a state where the panel connection portion is fixed to the clamp attachment hole, and
wherein a variation in a separation distance between the clamping members fixed to the bundle of the wires is prevented by the rigidity of the rod-shaped member.
